(19) United States
(12) Patent Application Publication
(10) Pub. No.: US 2011/0188520 A1
(43) Pub. Date: Aug. 4, 2011

(54) Method for operating a time-controlled bus system

(76) Inventors: Josef Newald, Stuttgart (DE); Alexander Lang, Neckarsulm (DE); Arup Mukherji, Bangalore (IN)

(21) Appl. No.: 12/931,500

(22) Filed: Feb. 1, 2011

(30) Foreign Application Priority Data
Feb. 4, 2010 (DE) 10 2010 001 596.2

(51) Int. Cl. H04J 3/06

(52) U.S. Cl. 370/503

(57) ABSTRACT

In a method for operating a time-controlled bus system, which communicates in communication slots in a sequence of communication cycles, a processing instruction, which is automatically generated from input data and configuration data, is used for processing communication tasks on the basis of time signals, the input data containing identifiers to identify the communication tasks, cycle information to assign the communication tasks to at least one communication cycle, and time position information to terminate the communication tasks within at least one communication cycle, and the configuration data contain data which define the communication tasks and/or describe the bus system.

### BACKGROUND OF THE INVENTION

1. Field of the Invention

The present invention relates to a method for operating a time-controlled bus system, which communicates in communication slots in a sequence of communication cycles, employing a processing instruction, which is automatically generated from input data and configuration data, for processing communication tasks on the basis of time signals, a method for generating a corresponding processing instruction, and a corresponding computer program product.

2. Description of the Related Art

Although the present invention is described predominantly in reference to the FlexRay field bus system, it is not restricted thereto, but rather is fundamentally usable in manifold time-controlled buses, for example, in SAFEbus, ARINC 659, SPIDER, NASA, TTCAN, and time-triggered protocol systems.

Primarily time-controlled and primarily event-controlled bus systems are known for use in vehicles. In time-controlled systems, which may additionally also contain features of event-controlled systems (not explained in greater detail here), the activation of functions and the transmission of messages is typically bound to predetermined points in time, which are defined, for example, on the basis of global time, which is known in the bus users by a synchronization of local clocks with the global time.

In contrast to the event-controlled communication, time-controlled systems typically at least partially have deterministic character in the sense that an established communication slot or time slot is assigned to every user in the communication system. Every user therefore has a guaranteed transmission and/or reception slot, which is available to him in a secured way because of a previously performed configuration.

FlexRay is a serial, deterministic, and error-tolerant field bus system for use in automobiles. Because of the above-mentioned features of time-controlled systems, inter alia, a higher data transmission rate, at least partial real-time capability, and high fault tolerance may be achieved by FlexRay, which are conditions in particular for so-called X-by-wire systems (drive-by-wire, steer-by-wire, brake-by-wire, etc.).

The bus protocol provided in the scope of FlexRay regulates, as the network starts, how the bus cycle is established and which control units may transmit at which point in time. A so-called communication controller implements the global bus protocol in each individual control unit, in that it packs the information to be transmitted in a data packet, for example, and transfers it at the correct point in time to the bus transceiver for transmission.

The communication on the bus runs in cycles. Each of the maximum 64 cycles is essentially divided into two time ranges. In a first, static range, which corresponds to the deterministic part of the FlexRay protocol, an established time slot is always assigned to every control unit or communication user, in which it may transmit messages. It may not exceed the chronological length of its slot. If the message is too long, the next cycle or the dynamic range following the static range must be used to continue the message. It may be ensured by the deterministic character of this part of the protocol that important messages (e.g., from steering, brake system, and the like) are transmitted at and within a known time.

The dynamic range following the static range may be used by a control unit to transmit longer or additional messages, for example, if the width of its static slot is not sufficient or is required for more important messages. If a control unit does not wish to transmit a message, the corresponding time slot (also referred to as a “minislot” in the dynamic range) runs out unused. This protocol part is comparable to the CAN bus in its transmission structure.

The assignment of the slots to individual bus users and the processing of the communication tasks is performed as provided in a previously defined configuration. The central element of the FlexRay configuration is the so-called FlexRay schedule. The FlexRay schedule may be understood as a binding transmission plan, which regulates the assignment of the slots to the individual users and establishes an assignment of the signals in each case.

Essentially two methods are known for transmitting and/or receiving messages via a time-synchronous bus, such as FlexRay or TTCAN.

In the scope of the MEDC17 method, which was developed by the applicant, all messages to be transmitted are transmitted periodically and all messages to be received are received periodically. In this way, MEDC17 makes it easier to configure a corresponding bus, since only slight dependencies occur between individual tasks and/or bus users, which must possibly be resolved.

However, unnecessary run time and thus energy is consumed in the microcontroller by the request of all messages to be transmitted or received, which is performed in the scope of MEDC17. Specific advantageous properties of time-synchronous bus systems (e.g., a bus-synchronous location of so-called protocol data unit (PDU)) therefore may not be used.

The AUTOSAR method, which is also known, includes the preparation of a list (“job list”) of the communication tasks synchronous with the time-synchronous bus (FlexRay or TTCAN). Because of the restrictions of the available software means, the preparation of the job list must be performed essentially “by hand” by experts. A corresponding AUTOSAR configuration may therefore only be performed by integrators having expert knowledge.

The so-called field bus exchange format (FIBEX), which has been established for the FlexRay bus system as a standard, is a data exchange format, which was defined by the Association for Standardization of Automation and Measuring Systems (ASAM), between tools which operate using message-oriented bus communication systems.

Complex communications systems may be summarized in a file having a uniform format using FIBEX. FIBEX is a description language based on XML, which contains all information to image a complete onboard network of a vehicle. This includes, inter alia, the topology, configuration parameters, schedules, frames, and signals up to their coding at the bit level.

FIBEX-XML files describe the structure and the communication behavior of passenger automobile onboard networks, as well as methods, using which raw data, which are transmitted on a data bus, may be converted into physical signals. As a standardized description language, FIBEX simplifies the data exchange between all participants in a project. FIBEX files may be very expensive and complex and may include 200 or more parameters.

In the scope of AUTOSAR, however, no algorithms are defined which make it possible, for example, to create a job list from a FIBEX configuration of a time-synchronous bus.

The need therefore exists for methods for operating time-synchronous bus systems on the basis of optimized processing instructions, which are automatically prepared employing FIBEX configuration files, for example, and substantially without user interaction.

### BRIEF SUMMARY OF THE INVENTION

The present invention provides a method for operating a time-controlled bus system, which communicates in communication slots in a sequence of communication cycles, employing a processing instruction, which is automatically generated from input data and configuration data, for processing communication tasks on the basis of time signals, a method for generating a corresponding processing instruction, and a corresponding computer program product.

As noted, FlexRay is a time-synchronous bus protocol, which transmits so-called frames, i.e., signals, in repetitive communication cycles. The FlexRay protocol operates on the basis of a global time base, which is implemented in every communication user. Time specifications are performed in the form of system-wide uniform so-called macroticks, which are multiples of the particular local time base (microticks corresponding to one cycle of a local oscillator, for example). The nominal absolute duration of one macrotick is identical in the entire FlexRay system. FlexRay operates in a total of at most 64 sequential communication cycles. After passage of the last (at most sixty-fourth) cycle, the cycle sequence begins again with the first cycle (wrap around). Within each communication cycle, frames are transmitted and received at an established time, which is defined by a particular time offset, expressed in the form of a macrotick value in relation to the cycle beginning. A chronological termination in the scope of FlexRay may therefore be performed on the basis of cycle information (the running number of the particular cycle) and time offset information.

The communication on the FlexRay bus occurs, as also noted, on the basis of a global FlexRay schedule. In a so-called job list, the processing of communication tasks (jobs) is established. The job list is triggered to process the tasks via absolute time signals (interrupts), the particular cycle and macrotick values of the interrupts being stored in the job list (for correlation of the absolute position with the corresponding cycle and the offset). Furthermore, a job list contains references (pointers) to particular frames Tx or Rx to be transmitted or received, respectively.

The present invention allows operation of a time-controlled bus system operating on the basis of a repetitive sequence of communication cycles, for example, a FlexRay bus, a processing instruction, which is automatically generated from input data and configuration data, being used for processing communication tasks on the basis of time signals.

Via the input data, a user or configurator of a corresponding bus system may specify identifiers to identify the communication tasks, cycle information to assign the communication tasks to at least one communication cycle, and time offset information to terminate the communication tasks within at least one communication cycle. The input data may advantageously be requested very easily by a software wizard. On the other hand, configuration data used for preparing the processing instruction contain data which define the communication tasks and/or describe the bus system, in particular in the form of a FIBEX configuration file.

The automatic generation of the processing instruction is subsequently performed completely automatically and at least includes the creation of a time sequence of the communication tasks on the basis of the cycle information and the time offset information from the input data, optionally the adaptation of the time offset information on the basis of time delay information, and the synchronization of the processing instruction with the time-synchronous bus system.

On the basis of the measures according to the present invention, a very simple and user-friendly configuration of a corresponding bus system is made possible via automatic creation of optimized, i.e., resource-optimal processing instructions, from an existing configuration file.

The computer program product according to the present invention having program code means, which are stored on a computer-readable data carrier, is provided for the purpose of executing the method according to the present invention when the computer program is executed on a computer or a corresponding computing unit, in particular in the control unit according to the present invention. In this way, for example, a particularly user-friendly request of the input data may be performed by a wizard function.

### BRIEF DESCRIPTION OF THE DRAWINGS

FIG. 1 shows a view of the FlexRay communication scheme according to the related art.

FIG. 2 shows a view of the FlexRay communication scheme according to the related art in a detail view.

FIG. 3 shows a schematic view of the processing of time delay information according to an embodiment of the present invention.

FIG. 4 shows a schematic view of the adaptation of time position information according to an embodiment of the present invention.

FIG. 5 shows a schematic view of the sequence of the method according to an embodiment of the present invention.

### DETAILED DESCRIPTION OF THE INVENTION

Elements corresponding to one another are specified by identical reference signs in the following figures, a repeated explanation being dispensed with for the sake of simplicity.

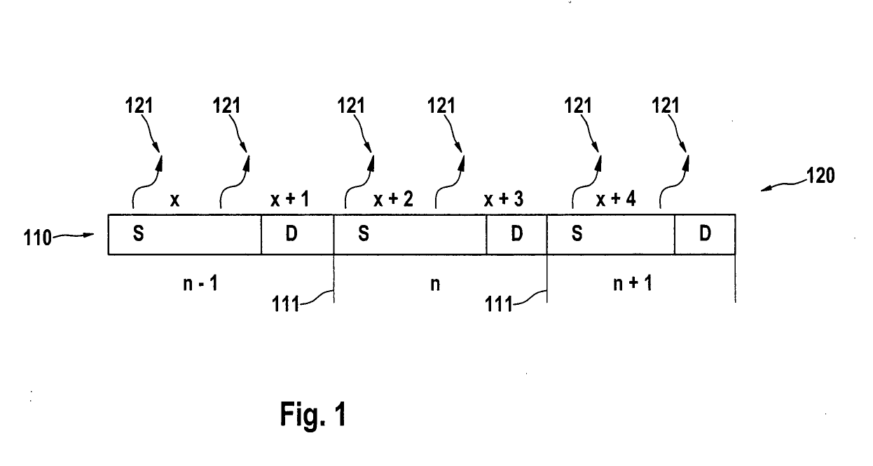

In FIG. 1, in the lower area, referred to a whole by 110, three (of a total of 64) FlexRay cycles n−1, n, and n+1 are shown between cycle boundaries 111. Cycles n−1, n, and n+1 each have a static segment S and a dynamic segment D. To avoid confusion with the time sections to be considered hereafter, which are also referred to as “segments”, between interrupts (see below), the term “communication range” is used in each case hereafter for static and dynamic FlexRay segments S and D, notwithstanding the typical terminology.

In the upper part of FIG. 1, referred to as a whole by 120, a total of five complete job list segments x, x+1, x+2, x+3, and x+4 are shown, divided by interrupts 121. The processing of a job list is performed in such a way that in the event of an occurrence of an interrupt 121, the next job is always retrieved from a job list configuration table. The subsequent interrupt is then configured on the basis of the (known) cycle and time offset information. In other words, cycle and time offset information for the subsequent interrupt point in time (based on the global time) is contained in the job list and thus configured. The communication controller (or a system timer) is programmed using these values and then triggers the next interrupt. As soon as this is performed, the communication operations (transmit/receive) of the current job are executed.

As noted, the job list is triggered by the interrupts on the basis of an absolute time. However, using a job list which operates without interrupts in the scope of the method according to the present invention is also considered. In this case, the interrupts may be replaced by “polling”—which is known per se. In contrast, if the operating system already runs synchronous with the global time, the interrupts may be replaced by “normal” tasks.

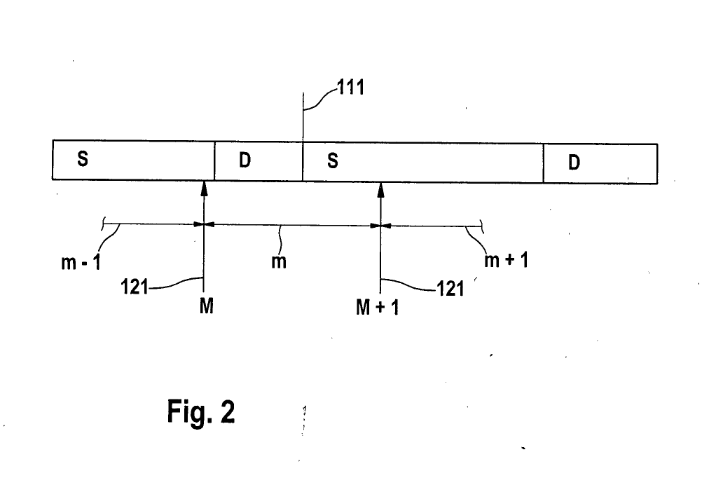

In relation to an established communication cycle n−1, n, n+1, each interrupt position corresponds to a value which is established from a cycle value and an offset value within the particular cycle (in macroticks, referred to hereafter as “time position information”). This state of affairs is illustrated in FIG. 2.

A total of two FlexRay cycles n and n+1, which are separated by a cycle boundary 111, and which each have static and dynamic communication ranges S and D, are shown in FIG. 2. Furthermore, job list interrupts 121, referred to as M and M+1, are shown. Values M and M+1 correspond to a job index (identifier) of the job list configuration table. A segment m may be understood as the time difference between timestamps M+1 and M, which are expressed by the particular cycle information (i.e., n or n+1 here), and an associated offset value. Further segments are specified by m−1 and m+1. The present invention thus defines segments m−1, m, and m+1, which span cycle boundaries.

A typical job list configuration table, which is not yet filled with values, is schematically shown in the following table.

| | | | | |
|---|---|---|---|---|
| Job index | Cycle | Offset | Tx | Rx |

0
1
. . .
K (total number of jobs)

The value “job index” in the job list identifies the current job or its interrupt position (M, M+1, etc., each related to the global time). In total, a number K of jobs may be configured, corresponding to the maximum number of possible interrupts. Under the entry “cycle”, for each job index, the corresponding FlexRay communication cycle is listed, in which the job is executed. The time position (in macroticks) within the cycle, at which the job is executed, is specified by “offset”. “Tx” and “Rx” represent pointers at communication tasks to be executed in the form of arrays. If no values are provided for Tx and/or Rx, the corresponding field contains a null pointer, for example. A corresponding array is not generated.

Interrupt M of FIG. 2 corresponds to an established job index of the preceding table (0, 1, 2, . . . ). Since interrupt M in the example of FIG. 2 falls in cycle n, parameter “cycle” has value n for this interrupt (or the job connected thereto). Parameter “offset” specifies the position of interrupt M within cycle n in macroticks. Correspondingly, parameter “cycle” has value n+1 for next interrupt M+1, since interrupt M+1 falls in cycle n+1, etc. Each line offset of the job list configuration table shown in the above table thus corresponds to a segment m−1, m, m+1, which is between two interrupts. Values Tx and Rx accordingly correspond to the particular communication tasks to be processed in this segment, i.e., for example, transmit and receive frames to be transmitted and received, the configuration of buffers or resources in the communication controller, etc.

A job list having all entries may advantageously be prepared and used completely automatically on the basis of the present invention.

For this purpose, input data and configuration data are processed. As previously explained, FIBEX-XML configuration files, which are typically used for the configuration of time-controlled bus systems, do not allow specification of job list features. Therefore, these additional required features are provided in the form of input data. The provision is preferably performed by a request using a software wizard.

On the basis of a preparation specification provided according to the present invention, a job list, which may be used to configure a corresponding time-synchronous bus system, is prepared from the input data and the configuration data, in particular from FIBEX-XML data and/or an AUTOSAR configuration file. The time-synchronous bus is operated employing the job list. Alternatively, the job list may also be output in suitable form, for example, in the form of C-source text files and associated header files, and/or in the form of an AUTOSAR file. An automatic conversion of an AUTOSAR file into a C-source text file is also possible. The user may thus prepare a processing instruction in the form of a job list very easily and simply. Expert knowledge on the configuration or preparation of an AUTOSAR file, which, as previously explained, was required up to this point for AUTOSAR operation, is not required.

The configuration data are not explained in greater detail here, since the FIBEX file format is generally known. In particular, configuration data have all relative parameters such as topology, configuration parameters, and/or frames of a corresponding bus system.

The method according to the present invention is not restricted to the preparation of a job list, however. If a job list is not provided or its use is dispensed with, the FlexRay driver moves cyclically over all existing buffers and requests frames to be transmitted or received, as is also performed in the scope of the above-explained MEDC17 method. As already previously explained, processing a job list without interrupts is also considered.

If a job list is to be used, the input data must have a minimum content, which corresponds to the following form, for example:

### Frlf_JobName01 (BaseCycle, CycleRepetition, MacrotickOffset)

### Frlf_JobName02 (BaseCycle, CycleRepetition, MacrotickOffset)

In this case, the input data have job information or task information for two jobs to be processed. JobName01 represents a unique identifier for a first job, for example, and JobName02 accordingly represents a unique identifier for a second job.

The value BaseCycle specifies the first FlexRay cycle in which the job is to be executed in each case. They cycle may be identical or different for different jobs. CycleRepetition specifies in how many and/or in which cycles the corresponding job is to be executed, for example, it may be specified by “1” that the job is executed in every cycle (following the base cycle specified by BaseCycle). Finally, MacrotickOffset identifies the chronological classification or termination of the job within the cycle, as previously explained. CycleRepetition and MacrotickOffset may also be identical or different for different jobs.

For example, the job information which is provided in the input data may assume the following values:

### JobName01 (0, 1, 400)

### JobName02 (0, 1, 3000)

It is thus defined in the input data that a first job having identification JobName01 is to be executed from the zeroth cycle (BaseCycle=0) in every cycle (CycleRepetition=1) at a macrotick position of 400 (MacrotickOffset=400). Accordingly, a second job having identification JobName02 is also to be executed from the zeroth cycle (BaseCycle=0) and in every cycle (CycleRepetition=1), but at a macrotick position of 3000 (MacrotickOffset=3000). The job information which is provided in the input data is converted together with the configuration data into a job list configuration table.

Accordingly, for example, a cycle time, absolute timer values, and timer values assigned to the interrupts, i.e., absolute positions of the interrupts, are ascertained from the configuration data.

In a first step for preparing the job list, a time sequence of the communication tasks is created, i.e., the jobs characterized by the particular identifiers, on the basis of the cycle information and the time offset information, i.e., on the basis of the values BaseCycle, CycleRepetition, and MacrotickOffset. The time sequence may be stored in a job list or buffered in another way. The time sequence is created, for example, by arranging the jobs in ascending sequence, first according to the cycle information and subsequently according to the offset information. A preliminary (“first”) job list originating therefrom, which was created using the above information relating to JobName01 and JobName02, is shown in the following table.

| | | | | |
|---|---|---|---|---|
| Job index | Cycle | Offset | Tx | Rx |

| | | |
|---|---|---|
| 0 | 0 | 400 |
| 1 | 0 | 3000 |
| 2 | 1 | 400 |
| 3 | 1 | 3000 |
| . . . | | |
| K (total number | | |
| of jobs) | | |

A second job list, in which so-called job delays in the form of positive or negative time shift values are considered, is created from the first job list thus created. Positive time shift values (+ve delay) may be required to compensate for high interrupt latency times, for example. This time shift value typically considers the time difference between target time and actual time of an interrupt (i.e., an interrupt latency time) and corresponds, for example, to the actual time of the interrupt and a first code execution time of an ISR routine. Vice versa, negative time shift values may be required to achieve a more rapid response time, in order to prepare data beforehand for a transmission, for example.

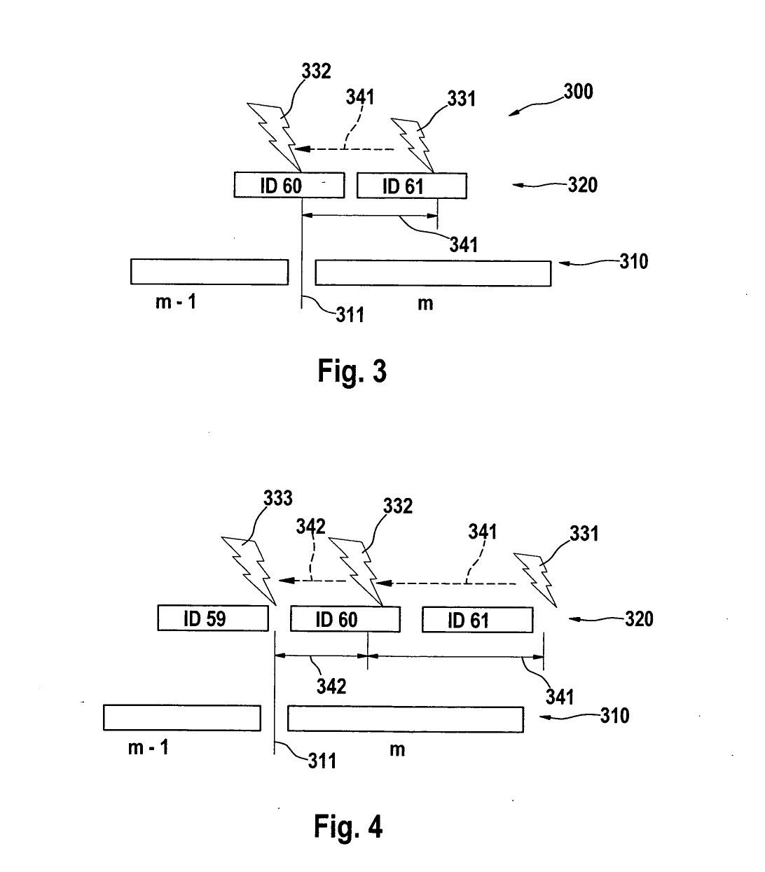

In FIG. 3, the time shift according to the present invention by the time shift values is shown and referred to as a whole by 300. In the lower part of FIG. 3, referred to by 310, two segments m−1 and m are schematically shown. A segment boundary 311 exists between these segments. In the upper part 320 of FIG. 3, slots having designation ID 60 and ID 61 are shown. These slots may be slots of dynamic and/or static communication ranges of a communication cycle, for example. One original interrupt request, which was not yet shifted by the time shift value, is specified by 331, while 332 refers to a “virtual” interrupt after a corresponding consideration of a time shift value, for example, in the scope of a latency time correction. The shift value is specified by 341. The shift value in the context of a job delay correction may be −40 macroticks, for example. As shown in FIG. 3, interrupt request 332 does not yet correspond to the boundary between slots ID 60 and ID 61.

The user may specify separate values for positive time shift and negative time shift, which may also be stored in the configuration data. Through the shift of the execution times by the time shift values, a virtual interrupt system is more or less created, which is still to be reconciled with the real slot boundaries between static slots and dynamic slots of the static and dynamic communication ranges.

The reconciliation to the real slot boundaries is advantageously performed using a method which is explained hereafter. The effect of this measure is illustrated in FIG. 4, where segments m−1 and m and a segment boundary 311 are specified, as in FIG. 3. In contrast to FIG. 3, in FIG. 4, three slots ID 59, ID 60, and ID 61 of a dynamic or static communication range of a FlexRay cycle are specified. Firstly, as above, one original interrupt request 331 is corrected by a shift of a time shift value 341 with creation of a virtual interrupt 332. As shown in FIG. 4, this virtual interrupt does not correspond to the slot boundary between slots ID 60 and ID 61. Virtual interrupt 332 must therefore be synchronized with a slot boundary. For this purpose, the slot boundary between slots ID 59 and ID 60 is used. The result of this synchronization is specified by 333, as a further virtual interrupt.

This slot boundary alignment will now be explained. The values which specify the particular slot ID and the particular position are taken from the configuration data, for example, the FIBEX-XML file.

It is now to be differentiated whether static FlexRay slots of the static communication range or dynamic slots (minislots) of the dynamic communication range are considered. The following equation applies for static slots, Gd_Static_Slot referring to the length of the static slot:

$$Virtual Tx / Rx interrupt position ( N - 1 ) < ( Tx / Rx \text{-} Slot \text{-} ID \times Gd\_Static \_Slot ) \leq virtual Tx / Rx interrupt ( N )$$

A separate calculation is performed in each case for Tx and Rx frames, since their virtual interrupts may differ, as previously explained.

For dynamic slots, the following equation accordingly applies, having Gd_MaxDynamicLength as the maximum length of a dynamic slot (minislot):

$$Virtual Tx / Rx interrupt position ( N - 1 ) < ( Tx / Rx \text{-} Slot \text{-} ID \times Gd\_MaxDynamicLength ) \leq virtual Tx / Rx interrupt ( N )$$

Because of the above-explained measures, an alignment of the slot boundaries with the interrupts or interrupt requests has essentially been performed.

For use in a time-controlled bus system, the created job list must be synchronized in a real-time environment. For this purpose, a rule is used which is employed for the transmission and reception of FlexRay frames as provided in the static configuration, as previously explained.

A FlexRay cluster, which is in the state “normal active”, renews its status variables. The FlexRay timer interrupts thus become active.

The following method is executed:
1. When a cluster (communication user) is in the state “normal active”, it reads the FlexRay global time, i.e., the current cycle and macrotick position (curr_cycle and curr_macro_tick).
2. A suitable cycle time shift value is added to the current cycle value (curr_cycle+=CYCLE_DELAY, for example, 10 ms). CYCLE DELAY acts as a safety buffer, in order to align the job list scheduler.
3. One optimized search routine is executed to find a job index, whose cycle value is greater than or equal to the current cycle: Job_Index→cycle≧curr_cycle.
4. When the search routine returns a result, the next FlexRay timer interrupt is set to the corresponding cycle and macrotick value of Job_Index.
5. After synchronization of the job list, the timer interrupt for the next job is retrieved from the job list table, as soon as a timer interrupt for the current job is established.
6. Communication tasks, for example, in the form of Tx and Rx frames, are retrieved from the job list table, Tx frames are transmitted and the Rx frames are received and/or processed for the current job.
   Steps 5 and 6 are repeated as long as the communication controller is synchronous with global time or the bus. A wrap around is optionally also to be considered here.
7. As soon as a synchronization loss of the FlexRay controller occurs, the rule from step 1 is executed again (wrap around).

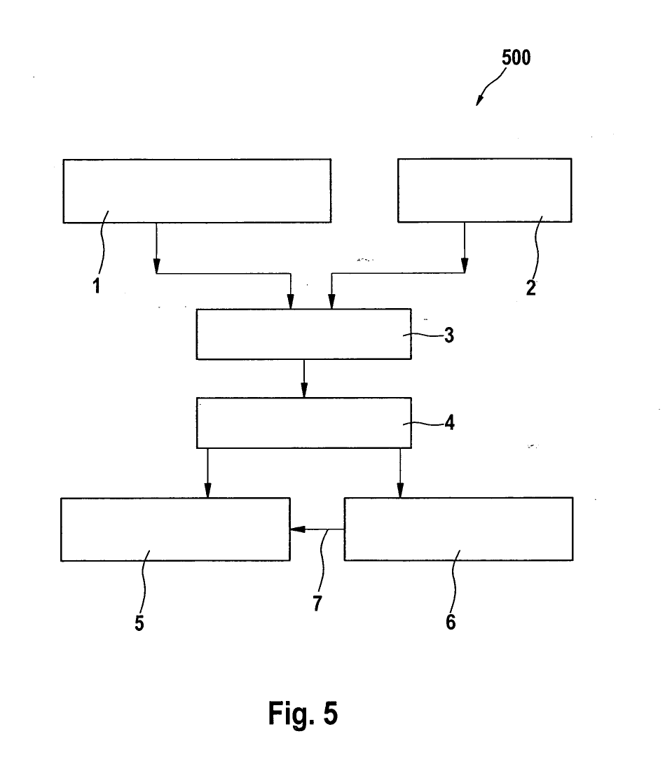

The method according to the present invention may advantageously be used in the scope of a preparation rule for a job list configuration table, as schematically shown in FIG. 5 and referred to by 500.

The method uses two data sources for above-explained input data 1 and configuration data 2, for example, a FIBEX configuration file 2. In step 3, a job list configuration table 4 is created and output from these data using a job list abstraction method, as previously explained. This job list configuration table 4 may be readily used for operating a time-controlled bus system. Alternatively, a C-source text file (for example, for use in activation software) having associated header file may also be created in step 5 and/or an AUTOSAR-XML file having job list details may be created in step 6. A corresponding C-source text file having associated header file may also be created from the corresponding AUTOSAR-XML file, as illustrated by sequence arrow 7.

What is claimed is:

1. A method for operating a time-controlled bus system configured to provide communication on the bus system in communication slots in a sequence of communication cycles, comprising:
generating a processing instruction used for processing communication tasks on the basis of time signals, wherein the processing instruction is automatically generated from input data and configuration data, the input data containing identifiers to identify the communication tasks, cycle information to assign the communication tasks to at least one communication cycle, and time position information to terminate the communication tasks within at least one communication cycle, and the configuration data containing data at least one of defining the communication tasks and describing the bus system, and wherein the automatic generation of the processing instruction includes at least the following:
a) creating a time sequence of the communication tasks on the basis of the cycle information and the time position information;
b) adapting the time position information on the basis of at least one of time offset information and boundaries of the communication slots; and
c) synchronizing the processing instruction with the time-controlled bus system.

2. The method as recited in claim 1, wherein the input data are at least partially provided by employing a user request function.

3. The method as recited in claim 1, wherein the configuration data are at least partially provided in the form of a configuration file containing information specific to control units.

4. The method as recited in claim 3, wherein the creation of the time sequence of the communication tasks includes chronological classification of the communication tasks on the basis of the cycle information and the time position information.

5. The method as recited in claim 3, wherein the adaptation of the time position information includes time shift of the time position information by a predefined delay time.

6. The method as recited in claim 3, wherein the adaptation of the time position information includes chronological alignment with segment boundaries within the communication cycles.

7. The method as recited in claim 3, wherein the communication tasks are processed in at least one of a FlexRay, a SAFEbus, a SPIDER, a TTCAN, and a time-triggered protocol bus system.

8. The method as recited in claim 3, further comprising:
outputting the processing instruction as a configuration file including at least one of an AUTOSAR-XML file and a C-source text file having assigned header file.

9. A method for operating a time-controlled bus system configured to provide communication on the bus system on the basis of timer interrupts in a number of sequential communication cycles, which are each divided into segments, employing first data and second data, the method comprising:
generating a processing instruction used for processing communication tasks on the basis of time signals, wherein the processing instruction is automatically generated from input data and configuration data, the input data containing identifiers to identify the communication tasks, cycle information to assign the communication tasks to at least one communication cycle, and time position information to terminate the communication tasks within at least one communication cycle, and the configuration data containing data at least one of defining the communication tasks and describing the bus system, and wherein the automatic generation of the processing instruction includes at least the following:
a) creating a time sequence of the communication tasks on the basis of the cycle information and the time position information;
b) adapting the time position information on the basis of at least one of time offset information and boundaries of the communication slots; and
c) synchronizing the processing instruction with the time-controlled bus system.

10. A non-transitory computer-readable data storage medium storing a computer program having program codes which, when executed on a computer, controls a method for operating a time-controlled bus system configured to provide communication on the bus system on the basis of timer interrupts in a number of sequential communication cycles, which are each divided into segments, employing first data and second data, the method comprising:
generating a processing instruction used for processing communication tasks on the basis of time signals, wherein the processing instruction is automatically generated from input data and configuration data, the input data containing identifiers to identify the communication tasks, cycle information to assign the communication tasks to at least one communication cycle, and time position information to terminate the communication tasks within at least one communication cycle, and the configuration data containing data at least one of defining the communication tasks and describing the bus system, and wherein the automatic generation of the processing instruction includes at least the following:
a) creating a time sequence of the communication tasks on the basis of the cycle information and the time position information;
b) adapting the time position information on the basis of at least one of time offset information and boundaries of the communication slots; and
c) synchronizing the processing instruction with the time-controlled bus system.
